(19) United States
(12) Patent Application Publication
(10) Pub. No.: US 2017/0276282 A1
(43) Pub. Date: Sep. 28, 2017

(54) APPARATUS TO REPAIR PVC PIPE

(71) Applicant: Brian David Casagranda, Mission Viejo, CA (US)

(72) Inventor: Brian David Casagranda, Mission Viejo, CA (US)

(21) Appl. No.: 15/078,393

(22) Filed: Mar. 23, 2016

(51) Int. Cl. F16L 55/163

(52) U.S. Cl. CPC F16L 55/163

(57) ABSTRACT

A pipe repair apparatus to restore a damaged portion of a pipe includes an elongated rod having a first fastener coupled to a first end and a second fastener coupled to a second end, each fastener of the pair of fasteners coupled to a rope, a pair of end members coupled to the elongated rod, each end member of the pair of end members having a first disk coupled to either the first or second end of the rod and a second disk coupled to an intermediate portion of the rod, the first and second disks of each end member having a sheet coupled to edges of the first and second disks, and a generally cylindrical member slidably mounted to the rod and positioned between the pair of end members.

### BACKGROUND

The embodiments herein relate generally to devices for inspecting and/or repairing polyvinyl chloride (“PVC”) pipes.

PVC pipes are commonly installed underground for utility companies to run wires and/or cables from one location to another. It is not uncommon for PVC pipes to deform or become damaged during the installation process or from being buried underground for extended periods of time. In the latter case, weight of the surrounding compacted soil often compresses the PVC pipe over time. In these circumstances, the pipe's inner diameter becomes smaller at these damaged portions due to the pipe being crushed.

After a PVC pipe has been installed underground or during the examination process of a potentially damaged pipe, the internal diameter of the pipe is verified by pulling a cylindrical aluminum or steel mandrel that is slightly smaller than the internal diameter of the pipe being tested thru the pipe from one end to the other by means of a rope. A problem typically arises when the mandrel becomes stuck inside the pipe due to damage. Since current mandrels being used have no moving parts, once they become stuck inside the pipe they usually cannot be unstuck from the damaged area. In addition, these mandrels are not designed to repair the damaged section of the pipe when encountered. This is especially problematic for already installed underground pipes because the damaged portion of the pipe has to be located and exposed by digging the surrounding soil to perform the repair. This is time consuming and costly because the process has to be completed for all sections of pipe where internal damage is found.

Several devices for repairing pipes exist as disclosed in U.S. Pat. Nos. 6,019,136 and 4,602,495, and U.S. Patent Application Publication 2006/0130923, which comprise members that are disposed within pipes. However, these devices are limited because they do not free or dislodge from a damaged portion of pipe quickly and effectively.

As such, there is a need in the industry for a pipe repair apparatus that addresses the limitations of the prior art, which effectively repairs a damaged portion of a pipe and prevents the apparatus from becoming stuck therein.

### SUMMARY

A pipe repair apparatus to restore a damaged portion of a pipe is provided. The apparatus is configured to slide within an interior of the pipe to repair deformations in the damaged portion of the pipe while minimizing a likelihood the apparatus becomes stuck within the damaged portion of the pipe. The pipe repair apparatus comprises an elongated rod comprising a first end and a second end, the first end comprising a first fastener coupled thereto and the second end comprising a second fastener coupled thereto, each fastener of the pair of fasteners configured to be coupled to a rope, a pair of end members coupled to the elongated rod and comprising a first end member situated proximate the first end of the rod and a second end member situated proximate the second end of the rod, each end member of the pair of end members comprising a first disk coupled to either the first or second end of the rod and a second disk coupled to an intermediate portion of the rod, the first and second disks of each end member further comprising a sheet coupled to edges of the first and second disks, and a generally cylindrical member slidably mounted to the rod and positioned between the pair of end members, wherein the pipe repair apparatus is disposed within the pipe and configured to slide in a forward or backward direction by applying a pulling force to the rope coupled to either the first end or second end of the rod, wherein the cylindrical member caught in the damaged portion of the pipe is released by applying the pulling force to the rope coupled to either the first or second end of the rod to permit the rod to slide relative to the cylindrical member, thereby permitting one of the pair of end members to contact the cylindrical member to dislodge the cylindrical member from the damaged portion of the pipe.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the pipe repair apparatus;

FIG. 2 depicts a perspective view of certain embodiments of the pipe repair apparatus with several components removed;

FIG. 3 depicts an elevation view of certain embodiments of the pipe repair apparatus shown in use;

FIG. 4 depicts a cross-sectional view of certain embodiments of the pipe repair apparatus; and

FIG. 5 depicts a cross-sectional view of certain embodiments of the pipe repair apparatus taken along line 5-5 of FIG. 4.

### DETAILED DESCRIPTION OF CERTAIN EMBODIMENTS

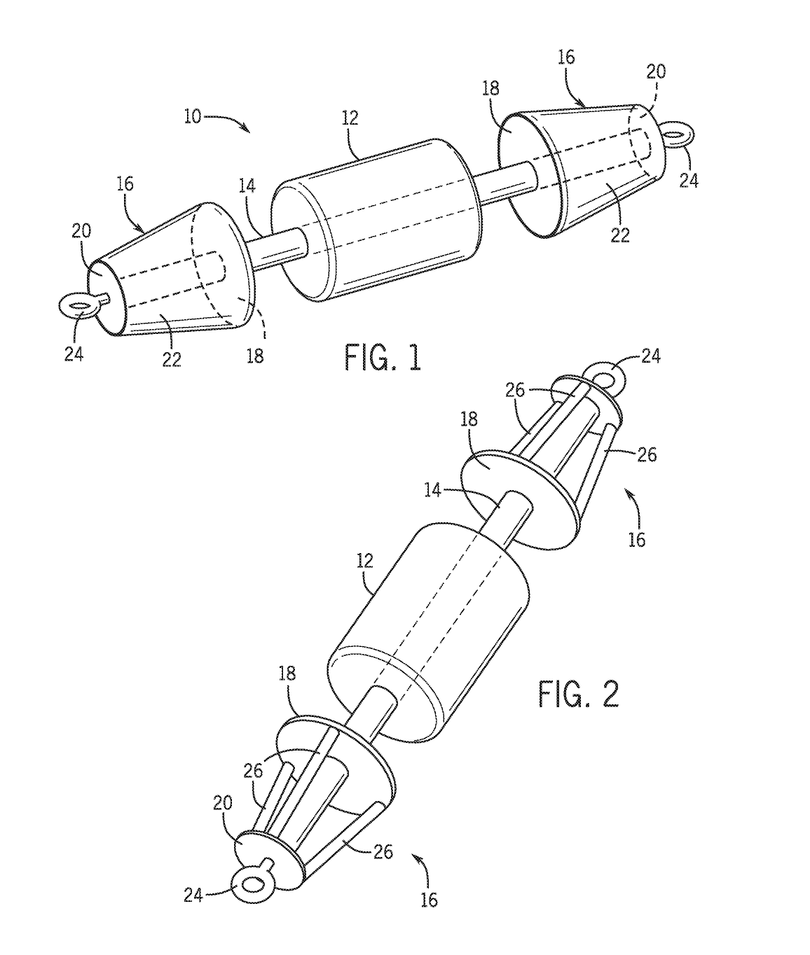

As depicted in FIGS. 1-3, pipe repair apparatus 10 generally comprises rod 14, cone assemblies 16 and mandrel 12, and is configured to be disposed within PVC pipe 30 to repair a damaged portion of the pipe. A user (not shown) maneuvers pipe repair apparatus 10 in a forward or backward direction within the interior of PVC pipe 30 by pulling ropes 28. In one embodiment, PVC pipe 30 comprises a diameter of approximately 3¾″. However, in certain embodiments, the diameter of PVC pipe 30 may be in the range of approximately 1″-6″.

Rod 14 is preferably made from steel and comprises an approximate length of 12″-21″ and diameter of ¼″-¾″. Each end of rod 14 comprises eye hook 24 coupled thereto. One of a pair of ropes 28 is tied to each eye hook 24. Mandrel 12 is a cylindrical member with a central opening extending along the longitudinal axis of the member. Rod 14 is inserted through the central opening of mandrel 12 to permit rod 14 to slidably adjust within mandrel 12. In a preferred embodiment, mandrel 12 is made from aluminum and is approximately 3″-6″ long with a diameter that is approximately ⅜″ smaller than the inner diameter of PVC pipe 30. However, the dimensions of mandrel 12 may vary.

Cone assemblies 16 are preferably made from steel and are coupled to the ends of rod 14. Each cone assembly 16 comprises first disk 20, second disk 18, struts 26 and sheet metal 22. At each end of rod 14, first disk 20 is welded to the end adjacent to eye hook 24. Second disk 18 is welded to an intermediate portion of rod 14. In a preferred embodiment, first disk 20 comprises a first diameter and second disk 18 comprises a second diameter that is greater than the first diameter.

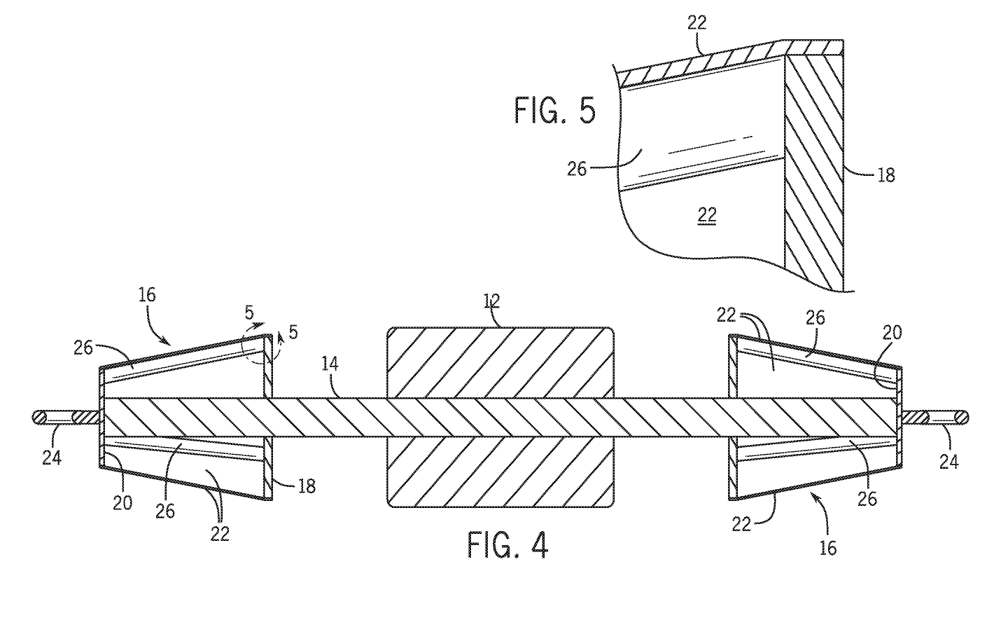

A plurality of struts 26 are welded to both first and second disks 20, 18 close to the edges of both disks. Struts 26 provide additional strength and stability to cone assembly 16. Although the figures depict three struts 26 coupled to first and second disks 20, 18, it shall be appreciated that any alternative number of struts 26 may be used instead. Sheet metal 22 is preferably made from 16-gauge steel sheet metal and is wrapped around the outer edges of first and second disks 20, 18. More specifically, sheet metal 22 is welded to the edges of first and second disks 20, 18. Since the diameter of first disk 20 is smaller than the diameter of second disk 18, sheet metal 22 forms a cone-like outer shape with first and second disks 20, 18. FIGS. 4-5 depict cross-sectional views of the assembled pipe repair apparatus 10.

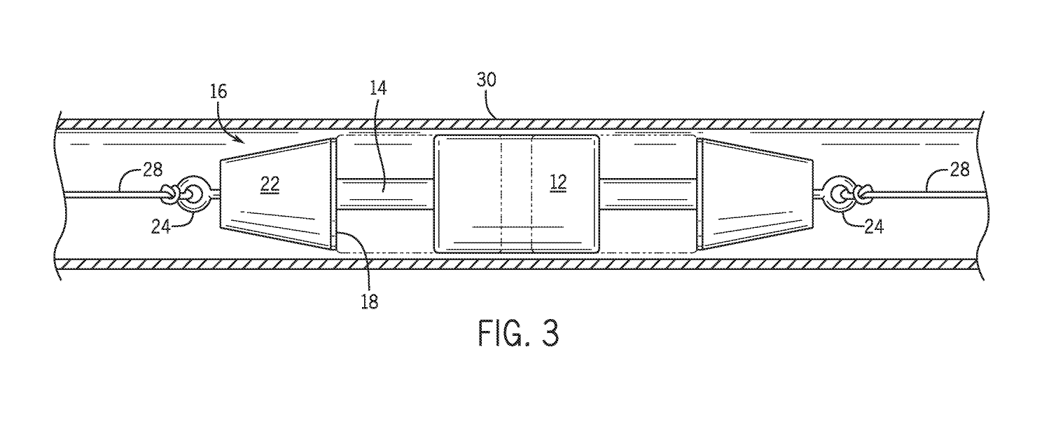

In operation, a user (not shown) maneuvers pipe repair apparatus 10 within PVC pipe 30 to verify the integrity of the pipe and/or repair a damaged section of the pipe. One of a pair of ropes 28 is tied to eye hook 24 at each end of rod 14. Pipe repair apparatus 10 is then disposed within PVC pipe 30 and pulled through via a leading rope 28 as shown in FIG. 3. If pipe repair apparatus 10 is pulled through the entirety of PVC pipe 30, from one end to the other end, the integrity of the pipe is verified. This means PVC pipe 30 is free from internal damage and/or obstructions. However, if pipe repair apparatus 10 becomes stuck within the interior of PVC pipe 30, this indicates mandrel 12 is stuck in a damaged portion of the pipe, i.e., crushed or egged portion of pipe. In this situation, the leading rope 28 and trailing rope 28 are each pulled one at a time. This permits rod 14 to slide within the interior of stuck mandrel 12 and enables second disk 18 of either cone assembly 16 to contact mandrel 12. The contact force between second disk 18 and mandrel 12 dislodges or frees the mandrel from the damaged portion of PVC pipe 30.

The leading rope 28 and trailing rope 28 are each pulled one at a time to cause pipe repair apparatus 10 to move in a forward and backward direction. During this process, mandrel 12 will eventually be pulled through the damaged portion of the pipe with a compressed internal diameter. The forward and backward motion of pipe repair apparatus 10 frees mandrel 12 if it becomes stuck again and ultimately reshapes the damaged portion of PVC pipe 30 back to factory dimensions as it is pulled through the pipe. Second disks 18 of cone assemblies 16 have a slightly smaller diameter than mandrel 12. This aids in the pipe repair apparatus' ability to knock or free mandrel 12 from a stuck portion of the pipe upon contact between any second disk 18 and mandrel 12. Once pipe repair apparatus 10 has been pulled through the entirety of PVC pipe 30, the pipe is repaired and verified.

It shall be appreciated that the components of pipe repair apparatus 10 described in several embodiments herein may comprise any alternative known materials in the field and be of any color, size and/or dimensions. It shall be appreciated that the components of pipe repair apparatus 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A pipe repair apparatus to restore a damaged portion of a pipe, the apparatus configured to slide within an interior of the pipe to repair deformations in the damaged portion of the pipe while minimizing a likelihood the apparatus becomes stuck within the damaged portion of the pipe, the pipe repair apparatus comprising:
an elongated rod comprising a first end and a second end, the first end comprising a first fastener coupled thereto and the second end comprising a second fastener coupled thereto, each fastener of the pair of fasteners configured to be coupled to a rope;
a pair of end members coupled to the elongated rod and comprising a first end member situated proximate the first end of the rod and a second end member situated proximate the second end of the rod, each end member of the pair of end members comprising a first disk coupled to either the first or second end of the rod and a second disk coupled to an intermediate portion of the rod, the first and second disks of each end member further comprising a sheet coupled to edges of the first and second disks; and
a generally cylindrical member slidably mounted to the rod and positioned between the pair of end members;
wherein the pipe repair apparatus is disposed within the pipe and configured to slide in a forward or backward direction by applying a pulling force to the rope coupled to either the first end or second end of the rod, wherein the cylindrical member caught in the damaged portion of the pipe is released by applying the pulling force to the rope coupled to either the first or second end of the rod to permit the rod to slide relative to the cylindrical member, thereby permitting one of the pair of end members to contact the cylindrical member to dislodge the cylindrical member from the damaged portion of the pipe.

2. The pipe repair apparatus of claim 1, wherein the first disk of each end member comprises a first diameter and the second disk of each end member comprises a second diameter that is greater than the first diameter.

3. The pipe repair apparatus of claim 2, wherein each end member of the pair of end members comprises a plurality of struts coupled to both the first and second disks.

4. The pipe repair apparatus of claim 3, wherein the second diameter of each second disk is smaller than a third diameter of the cylindrical member.

5. The pipe repair apparatus of claim 4, wherein each fastener of the first and second fasteners comprises an eye hook.
